(19) United States
(12) Patent Application Publication
(10) Pub. No.: US 2014/0170359 A1
(43) Pub. Date: Jun. 19, 2014

(54) COVER LAYER WITH OUTSIDE FILM LAYER OF AN ELASTIC PLASTIC

(71) Applicants: Mondi Gronau GmbH, Gronau (DE); hülsta-werke Hüls GmbH & Co. KG, Stadtlohn (DE)

(72) Inventors: Richard Schwitte, Gescher (DE); Werner Steggemann, Stadtlohn (DE); Alexander Ohneiser, Altenberge (DE); Jan Zimmermann, Magdeburg (DE)

(73) Assignees: Mondi Gronau GmbH, Gronau (DE); hülsta-werke Hüls GmbH & Co. KG, Stadtlohn (DE)

(21) Appl. No.: 14/098,782

(22) Filed: Dec. 6, 2013

(30) Foreign Application Priority Data
Dec. 7, 2012 (DE) 10 2012 023 903.3
Apr. 26, 2013 (DE) 10 2013 007 236.0

(51) Int. Cl. C09J 7/04; B32B 27/10

(52) U.S. Cl. CPC C09J 7/048; B32B 27/10
USPC 428/41.5; 428/537.5; 428/41.7

(57) ABSTRACT

A cover layer (1) for a panel (3) which has a panel base body (2), such as a floor covering panel, wall panel or ceiling sheathing panel and/or furniture component panel, building panel, covering panel or dry finish panel and/or as a facade element, panel element or board element, trimming plate or the like, the cover layer (1) having a paper layer (4) and a film layer (6) of elastic plastic which forms the outside (5) of the cover layer (1). The paper layer (4) is made as a preimpregnate which has already been partially impregnated during paper manufacture or as paper, especially decorative paper, which has been partially impregnated after paper manufacture and before joining to the paper layer (4).

### BACKGROUND OF THE INVENTION

1. Field of the Invention

The invention relates to a cover layer for a panel which has a panel base body, such as a floor covering panel, wall panel or ceiling sheathing panel and/or furniture component panel, building panel, covering panel or dry finish panel and/or as a facade element, panel element or board element, trimming plate or the like, the cover layer having a paper layer and a film layer of elastic plastic which forms the outside of the cover layer. Furthermore, this invention relates to a multilayer elastic film layer for a cover layer of the aforementioned type and a panel with a cover layer of the aforementioned type.

2. Description of Related Art

A cover layer and panel of the aforementioned type in the form of a laminate floor panel are already known from European Patent Application EP 2 263 867 B1. When used as a laminate floor panel, the known panel is wherein the elastic outside of the cover layer yields not only a walking sensation which is pleasant for the user and which is different compared to known laminate floors, depending on the execution of the outside film layer there is also an distinct reduction in part of the footfall sound with the result that even underside footfall sound-damping materials can be omitted or their thickness can be greatly reduced. The elasticity of the surface of the cover layer also improves the properties with respect to compressive and impact stress of the products. Furthermore, the elasticity of the surface and the use of the elastic film layer pleasantly heat the feet, which is perceptible to the user.

Compared to hard laminate floors, a laminate floor which has been produced according to European Patent Application EP 2 263 867 B1 offers a series of major advantages. In “hard” laminate floors, with corresponding loading, cracks form in the overlay so that moisture and/or splinters limit the use of the laminate. Due to the elasticity of the outside film layer of elastic plastic, these problems do not arise. Moreover, for a soft cover layer a sharp edge cut is possible so that the white fracture which arises in the cutting of “hard” laminates does not occur. Moreover, it is such that in the use of an elastic upper plastic layer flaking on the edges is avoided. Therefore, when cutting individual panels, there are no adverse effects so that the optical-aesthetic impression is generally good.

Furthermore, it is such that, compared to “hard” laminate floors, the top film layer of elastic plastic yields improved cutting properties of the panel overall; as a result, this leads to an increase in the service life of the cutting tool.

Overall, a laminate floor panel with a cover layer which has an elastic film layer offers a host of advantages as compared to so-called “hard” laminate floors.

In the laminate floor panel known from European Patent Application EP 2 263 867 B 1, the cover layer has a decorative paper layer in addition to the film layer. The paper layer can be resin-loaded. The entire composite is produced by hot pressing by means of a KT press. To do this, a decorative paper is used which after printing is impregnated with artificial resin and is thoroughly resin-loaded. The impregnation resin solutions which are ordinarily used for impregnation of raw decorative paper are generally resins based on urea resins, melamine resins or phenolic resins. Alternatively, European Patent Application EP 2 263 867 B1 proposes using an unimpregnated decorative paper for the cover layer when a corresponding plastic of the film layer is used which provides not only for the bond between the decorative paper and the film layer, but also for strong connection to the support panel.

In tests which have been run in conjunction with the use of a panel which has been produced according to European Patent Application EP 2 263 867 B 1, it has been ascertained that the known panel exhibits average properties during use/loading.

### SUMMARY OF THE INVENTION

A primary object of this invention, at this point, is to improve the properties of the known panel.

This object is essentially achieved in that the paper layer is made as a preimpregnate (prepreg) which is already partially impregnated in paper manufacture or as paper, especially decorative paper, which has been partially impregnated after paper manufacture and before joining to the film layer. A preimpregnate is a paper which is made generally as decorative paper which is only partially impregnated online or offline in the paper-making machine. The alternatively used paper which is partially impregnated after paper manufacture and before joining to the film layer is one which is only partially impregnated or resin-loaded with a binder, differently than decorative papers with a paper core which has been thoroughly impregnated, which papers are intended for KT pressing.

As a result, the invention thus relates to a cover layer with improved properties which has a printed paper layer (decorative paper) and a multilayer elastic film layer which forms the outside of the cover layer.

Cover layers in accordance with the invention are used as decorative and protective layers for surfaces of wood materials, especially as overlay for producing novel laminate floor panels. In this case cover layers in accordance with the invention are applied using conventional methods to suitable carrier systems (for example, HDF panels, MDF panels, etc.). Due to the specific configuration of the cover layer, these panels have a series of advantages compared to laminate floor panels.

Cover layers in accordance with the invention have good acoustic properties, especially effective solid-borne sound damping. Furthermore, these cover layers have improved surface properties, mainly abrasion resistance is greatly enhanced. In particular, it is possible to provide the surface of the cover layer with a permanent structure which is modeled on the structure of wood materials. In addition, cover layers in accordance with the invention have improved properties with respect to peel strength, interlaminar strength and delamination strength; this is achieved by increased composite adhesion of the entire structure. Here especially, the interlaminar strength of the decorative paper and the joining of the individual layers to one another are optimized.

A typical structure of a cover layer in accordance with the invention has the following successive layers:

wear layer

functional layer

adhesive (boundary layer to paper)

printing ink/impregnation agent (boundary layer to the film layer)

paper.

Of the aforementioned layers, the wear layer, the functional layer and the adhesive constitute the multilayer, elastic film layer, while the printing ink/impregnation agent and the paper constitute the partially impregnated paper, especially decorative paper.

The elastic film layer which forms the outside of the cover layer can contain additives and/or can be inked, for example, for improving flame retardant properties, improving electrostatic behavior and the like. According to one preferred version of the invention, the film layer is made transparent, especially highly transparent so that the underlying decoration is visible. Here the polymers which have been used for producing the film layer must be lightfast and/or UV-resistant or must be stabilized by corresponding additives.

The film layer can have a three-dimensional surface structure which has been produced by embossing, and fine structures as are typical for veneers can be permanently introduced into the outer layer.

The cover layer in accordance with the invention has an outer layer (wear layer) of a physically or chemically cross-linked polymer and at least one functional layer consisting likewise of a physically or chemically cross-linked polymer. The functional layer is located on the underside of the outer layer and has a lower Shore hardness than the outer layer. Both the outer layer and also the functional layer have elastomer properties and preferably are composed of thermoplastic polymers which are physically cross-linked or are chemically cross-linked after their extrusion, i.e., subsequently.

Chemical cross-linking can be induced by subsequent irradiation of the extruded cover layer. The outer layer and the functional layer of the cover layer are preferably coextruded. The functional layer within the composite absorbs mechanical impacts and has an effective footfall-sound damping effect. The outer layer imparts to the surface a high scratch resistance, low abrasion values and pleasant feel. The outer layer (wear layer) can in particular have a Shore hardness of greater than 90 A to Shore 80 D, a hardness of roughly Shore 60 D being preferred. The Shore hardness of the functional layer is especially in the range Shore 50 A to a maximum Shore 90 A, for the functional layer a Shore hardness of roughly Shore 70 A being preferred. The outer layer and the functional layer can consist of olefin-based thermoplastic elastomers (TPE-O), cross-linked olefin-based thermoplastic elastomers (TPE-V), urethane-based thermoplastic elastomers (TPE-U), thermoplastic polyester elastomers (TPE-E), styrene block copolymers (TPE-S) or thermoplastic copolyamides (TPE-A). Preferably, the outer layer and the functional layer are comprised of urethane-based thermoplastic elastomers (TPE-U).

The thickness of the film layer is dependent on the application and can be varied in a wide range of parameters. As an overlay for producing novel laminate floor panels, the elastic film layer advantageously has a total thickness between 50 μm and 2000 μm, and the thickness of the functional layer should be greater by a factor of 2 to 100 than the thickness of the outer layer. The thickness of the outer layer can be varied between 5 μm and 200 μm. The functional layer can have a layer thickness between 60 μm and 1800 μm. According to one preferred version of the invention, especially for use as an overlay on laminate panels, the outer layer has a layer thickness between 10 μm and 50 μm and the functional layer has a layer thickness between 100 μm and 600 μm.

Another version of the cover layer in accordance with the invention is characterized by a layer arrangement composed of a plurality of coextruded layers each of which comprise a physically or subsequently chemically cross-linked thermoplastic polymer, hard layers with a Shore hardness corresponding to the outer layer or at least comparable to it and soft layers with a Shore hardness which corresponds to the functional layer or which is at least comparable to it being arranged in alternation. The sequence of hard layers and soft layers causes a better distribution of compressive loads and results in improved solid-borne sound damping or footfall-sound damping.

The cover layer preferably encompasses an adhesive layer which is located between the functional layer and the carrier paper. The adhesive layer ensures the joining of the film layer to the paper layer and is thus decisive for the entire composite adhesion of the cover layer. It greatly influences the peel strength, adhesive strength and inter-laminar strength of the cover layer and is, furthermore, relevant to the resulting optics of the cover layer. It must be configured such that a bonded and positive connection between the partially impregnated paper, especially decorative paper, and the film layer is achieved. To do this, the adhesive layer must be chemically matched both to the material of the functional layer and also to the material of the paper layer (essentially to the binder in the resin or printing ink). Depending on the specific configuration of the paper layer, different adhesives on the basis of a polyamide, acrylate or urethane-based copolymer or mixtures of them are used. By using pressure and/or temperature, the adhesive layer forms a positive combination with the pretreated paper layer, air inclusions or caverns between the paper layer and film layer being suppressed, i.e., at least essentially avoided, which have adverse effects on the visual appearance of the cover layer. The preferred method for joining of the paper layer and film layer is co-extrusion coating. If the functional layer itself has the aforementioned properties, under certain circumstances, a special adhesive layer can be omitted.

Even if, in accordance with this invention, fundamentally any paper can be used, preferably a decorative paper is used. A decorative paper is a special paper for surface enhancement of wood materials. In the field of special papers, the decorative papers belong among those papers with the highest growth rates due to continuously growing applications. Due to the demand high quality visual appearance, extremely high requirements are imposed on the decorative paper. The starting point for the production of these decorative papers is special raw paper types which have a weak pulp sizing and are comprised essentially of celluloses, pigments, fillers and conventional additives. The substance weights of decorative papers are conventionally between 20 g/m² to 1000 g/m², especially between 30 g/m² and 300 g/m².

The decorative paper can be coated or uncoated, and its surface must bind and hold printing inks, but nevertheless enable the absorption of a defined amount of aqueous resin or binder. Here, it is distinguished between preimpregnate s which are already impregnated during paper manufacture, and pos-timpregnates which are impregnated after paper manufacture and before joining to the film layer. Here, the dimensional behavior of the paper beyond the further processing steps should remain manageable. Furthermore, painting and de-flaking are important in decorative papers. The demands on the glazing process are continually increasing due to the higher and higher stipulations for the glazing values to improve printability. For optimum printability, the paper requires especially good formation, glaze and dimensional stability.

In accordance with the invention, it has been ascertained that, ultimately, only partially impregnated, therefore not thoroughly impregnated papers, regardless of whether preimpregnate s or post-impregnates, lead to greatly improved properties of the cover layer as compared to the cover layer with unimpregnated or thoroughly impregnated paper. In particular, improved properties with respect to peel strength, adhesive strength, inter-laminar strength and delamination strength arise. Since the curable resin is impregnated in carrier materials which are visible in the finished composite material, the resin must be transparent after curing, preferably colorlessly transparent. Moreover, it is desirable that the cured resin be lightfast and/or UV-resistant, i.e., it should not be discolor over time by the effect of light. Especially preferred resins which meet the demands for transparency and color-fastness can be chosen from aminoplastic resins, melamine resins, melamine ether resins, urea resins, polyester resins, acrylate dispersions, polyurethane dispersions, polyester resins, acrylate dispersions, polyurethane dispersions, epoxy resin dispersions and mixtures thereof.

Depending on the paper types used, in addition to the resin or binder which has been used for impregnation (post-impregnation) also the printing ink (preimpregnate) can constitute the boundary layer between the paper and film layer. To ensure corresponding composite adhesion, in this case, the printing inks used must exhibit chemical compatibility with the resin and adhesive. This is achieved by the use of additives and/or corresponding binders, especially acrylate-based or urethane-based. Depending on the printing method, the proportion of the binder varies between 12%-25%, and the proportion of additives can be up to 5%. Analogous to the components of the film layer or the resin systems used, the printing inks used must be colorfast upon exposure to light and/or UV-resistant.

Only decorative papers are addressed below. However, fundamentally, any other paper and especially any other special paper can also be used. The following statements on decorative papers therefore apply in the same way fundamentally to other papers as well.

Various properties are explained in detail below which arise due to the paper in accordance with the invention, therefore to the preimpregnate or to the decorative paper which is partially resin-loaded layer in the process, or to the only partial impregnation of the paper, and to the film layer. However, these properties are, in any case, dependent on the degree of partial impregnation, on the resin/binder used, on the raw paper used and on the matching of the paper, binder, degree of impregnation, printing ink and/or adhesive. With respect to these possible variations, the paper in accordance with the invention and the cover layer in accordance with the invention are defined based on the properties achieved.

One property which is important for a panel with a cover layer is the peel strength. The peel strength designates the resistivity of the connection to forces which act exclusively on a narrow edge region on the end of the connection, and thus, lead to stress peaks. It is provided in accordance with the invention that the peel strength of the cover layer as compared to the panel base body is greater than 1.5 N/cm and preferably greater than 2 N/cm. In particular, the peel strength is between 2.1 N/cm to 3.5 N/cm. In tests which have been run, peel strength values when using the partially impregnated paper in accordance with the invention of between 2 to 3 N/cm have been determined. For unimpregnated decorative papers from the prior art only peel strength values less than 1 N/cm have been obtained, and when using thoroughly impregnated decorative papers, values of less than 0.5 N/cm have been determined. Peel strength values which have been improved in this way when using the paper in accordance with the invention could not be readily expected. It was first inherently assumed that unimpregnated decorative papers would have very good peel strength since the unimpregnated decorative paper has a comparatively high porosity and allows deep penetration of the joining agent into the paper when using an underside glue layer or cement layer. However, when using the paper in accordance with the invention, peel strength which has been improved by more than 100%.

For thoroughly impregnated paper, it has been ascertained that it splits essentially between the layers both in the paper and also between the plastic layer and the actual paper layer. The paper is more highly sealed by thorough impregnation, and thus, is not so open-pored. Therefore, there is good adhesive strength between the plastic layer and the conventionally used decorative paper.

Another characterization criterion of the cover layer in accordance with the invention is the lattice cut characteristic value according to ISO 2409. Using the lattice cut the quality of the adhesive strength of a coating can be tested. In a lattice cut, six parallel cuts with a cutter blade are made which extend to the undersurface, however without damaging the undersurface. The distance of the cuts is 1 to 3 mm, depending on the layer thickness of the coating. Layer thicknesses between 60 and 120 mm require a distance of 2 mm here. Lower layer thicknesses require a distance of 1 mm, higher ones a distance of 3 mm. Afterwards, six further scratch cuts are made at a right angle so that a uniform square pattern arises. A transparent or crepe adhesive tape with an adhesive force of 8 to 10 N/25 mm is cemented onto the resulting square. It is pulled off in a time from 0.5 to 1 second at an angle of 60°, this being prescribed only for hard undersurfaces. Last, the remaining lattice is evaluated. Depending on the state, it is distinguished between lattice cut characteristic values (Gt) of 0 (very good adhesive strength) to 5 (very poor adhesive strength).

At a characteristic value Gt=0, there are completely smooth cut edges without flaking. A completely cleanly imaged lattice cut grid without any loss of coating arises.

At a characteristic value Gt=1, there is slight flaking on the cut points of the lattice lines, a coating loss which is not significantly more than 5% of the total lattice cut surface arising.

At Gt=2 there is flaking along the cut edges and/or on the cut points of the lattice lines of distinctly more than 5% up to slightly more than 15% of the entire lattice cut surface.

At Gt=3, there is flaking along the cut edges and/or of squares (in whole and in part), a coating loss of distinctly more than 15% up to slightly more than 35% of the entire lattice cut surface arising.

At Gt=4, a similar result to Gt equals 3 arises, but with a coating loss of distinctly more than 35% up to slightly more than 65% of the entire lattice cut surface.

Finally, Gt=5 means that there is flaking, whose coating loss is considerably more than 65% of the entire lattice cut surface and which accordingly can no longer be rated with the characteristic value “4”.

It was ascertained in completed tests that the cover layer in accordance with the invention has a lattice cut characteristic value Gt according to ISO 2409 of 3 or better, especially of 1 or 0.

In tests with an unimpregnated decorative paper and with a thoroughly impregnated decorative paper, lattice cut characteristic values were attained which were unexpectedly comparatively poor. Thus, Gt values between 4 and 5 were determined. In studies which were then done, it was ascertained that the top plastic coating apparently joins very poorly, on the one hand, to unimpregnated decorative paper, and on the other hand, to thoroughly impregnated decorative paper; this results in corresponding poor lattice cut characteristic values. It was ascertained that the plastic linkage has a good and strong connection to the unimpregnated, open-pored decorative paper. In any case, the paper splits. Conversely, a thorough impregnate is more highly sealed, and thus, not as open-pored as an unimpregnated decorative paper or a partially impregnated decorative paper. Thus, the adhesive strength between the plastic layer and the decorative paper is lower; this leads to splitting essentially between the plastic layer and the paper layer.

Furthermore, the cover layer in accordance with the invention, therefore, the paper layer including the film layer of elastic plastic, has greatly improved inter-laminar strength compared to the decorative paper of a film layer in conjunction with an unimpregnated decorative paper, on the one hand, and a film layer and a thoroughly resin-loaded decorative paper, on the other hand.

In tests, the inter-laminar strength was determined according to the Scott Bond method. Here, a sample strip of the cover layer is fastened with double-sided adhesive tape to an undersurface, such as an anvil. On the top, an angle is attached in the same manner to the test piece. The entire structure is compressed in a defined manner and then clamped in a measurement mount. By releasing a pendulum, the angle is knocked off the test piece. In doing so, the energy of the pendulum is reduced. The energy loss is set in relation to the sample area and given as a measured value (J/m²) from several measurements. This value thus describes the energy absorption relative to the contact surface.

In this connection, for a cover layer with an unimpregnated decorative paper a value of 600 J/m² and with a thoroughly impregnated decorative paper a value of 1000 J/m² were determined. Conversely, for a cover layer with a partially impregnated paper an unexpectedly high value of 2040 J/m² was reached.

It results from these specifically determined values that depending on the choice of the raw decorative paper and of the resin/binder used for partial impregnation, the inter-laminar strength of the cover layer in accordance with the invention should be greater than 1500 J/m² and preferably greater than 1800 J/m².

Moreover, the cover layer in accordance with the invention has a delamination strength according to EN 13329 that is greater than 0.7 N/mm², preferably between 0.95 N/mm² and 1.33 N/mm², and especially between 1 N/mm² and 1.3 N/mm². It was ascertained in completed tests that the cover layer in accordance with the invention achieves essentially the same delamination strength as a cover layer with a thoroughly impregnated decorative paper, specifically of roughly 1.18 N/mm², while for a cover layer with an unimpregnated decorative paper only a delamination strength of 0.46 N/mm² was achieved.

Other important characteristic values are the edge swelling and the water absorption of the raw paper before it is coated with the outside film layer. Edge swelling is an increase in the thickness of the raw paper in the region of the edge after the raw paper has been exposed to water over a time interval of 60 minutes. It was ascertained that the partial impregnation of the paper in accordance with the invention should be such that edge swelling is between 10 and 35%, preferably between 15 and 30% and especially between 20 and 25%. In one specific application of the cover layer in accordance with the invention, edge swelling of 22.46% was determined.

For a cover layer with an unimpregnated decorative paper, edge swelling of 43.07% and when using a thoroughly impregnated decorative paper an expected low edge swelling of 8.8% was determined. The water absorption in percentage is found from the following formula

WA=100×(m_{q}−mₑ)/mₑ

Where m_{q} is the mass of the swollen sample and mₑ is the mass of the dried sample. The partially impregnated paper which was used in accordance with the invention as raw paper has a water absorption after 15 minutes between 30 and 60%, preferably between 40 and 50% and especially between 43 and 47%. In a test with a preimpregnate, a level of water absorption of 45.14% was attained. In an unimpregnated decorative paper, a level of water absorption of 94.77%, and for a thoroughly impregnated decorative paper, a level of water absorption of 37.89% were measured.

As a result, it was ascertained that when using a thoroughly impregnated decorative paper as compared to a partially impregnated decorative paper, only in the region of the edge swelling and water absorption are more favorable properties achieved. These more favorable values can be qualified in any case since, for installed panels, anyway, there is a sealing effect in the region of the edges by the elastic plastic coating so that, ultimately, comparatively little moisture can travel into the decorative paper and especially into the edges. Moreover, between the thoroughly impregnated decorative paper and the partially impregnated decorative paper, essentially the same values arise for the delamination strength. However, the cover layer in accordance with the invention with the partially impregnated decorative paper is clearly superior compared to the cover layer with fully or unimpregnated cover layer for the peel strength, adhesive strength and inter-laminar strength. A cover layer with an unimpregnated decorative paper is inferior to the cover layer in accordance with the invention in all respects.

Ultimately, there is always a partial impregnation of the paper layer when there is a degree of impregnation greater than 0% as in unimpregnated decorative papers, and less than 100% as in thoroughly impregnated papers. Fundamentally, any individual value and any intermediate interval within the interval boundaries are possible. However, degrees of impregnation between 5 and 50% are preferred, more preferably between 10 and 40%, even more preferably between 15 and 35% and especially between 20 and 30%.

The invention also relates to a multilayer film which is suitable as a pre-product for producing the cover layer in accordance with the invention and which can be joined by bonding to a partially impregnated paper by using pressure and/or heat.

In conjunction with this invention it has also been ascertained that it is advantageous if the degree of impregnation of the paper increases from the top side to the bottom side. Here, the top side of the paper is the side on which there is the film layer of elastic plastic, while the bottom side constitutes the side of the paper layer facing the panel base body. Ultimately, it is such that a stronger impregnation on the bottom side leads to a good connection of the paper to the panel base body via the respective joining layer (adhesive layer or glue layer) while the reduced degree of impregnation on the top side leads to a very good connection to the outside film layer. Here, it goes without saying that depending on the choice of the plastic material for the film layer and of the material used for the respective joining layer, it is also fundamentally possible to have uniform partial impregnation.

Furthermore, this invention relates not only to the cover layer as such, but also to the combination of the cover layer joined to the panel base body, therefore a corresponding panel.

Otherwise, it goes without saying that, in the aforementioned intervals and range boundaries, any intermediate intervals and individual values are contained and can be considered disclosed as critical to the invention, even if these intermediate intervals and individual values are not specifically indicated.

Other features, advantages and possible applications of this invention will become apparent from the following description of exemplary embodiments in conjunction with the accompanying drawings and from the drawings themselves. All described and/or illustrated features for themselves or in any combination form the subject matter of this invention, regardless of their combination or their referencing.

### BRIEF DESCRIPTION OF THE DRAWINGS

FIG. 1 is a schematic cross-sectional view of one embodiment of a cover layer in accordance with the invention,

FIG. 2 is a schematic cross-sectional view of another embodiment of a cover layer in accordance with the invention,

FIG. 3 is a schematic view of a paper layer used in the cover layer in accordance with the invention,

FIG. 4 shows another embodiment of a paper layer used in the cover layer in accordance with the invention,

FIG. 5 is a schematic cross-sectional view of a panel in accordance with the invention with a cover layer,

FIG. 6 is a schematic cross-sectional view of a cover layer in accordance with the invention,

FIG. 7 shows the layer structure of a film used in the cover layer in accordance with the invention and

FIG. 8 shows another embodiment of a film which is suitable for producing the cover layer.

### DETAILED DESCRIPTION OF THE INVENTION

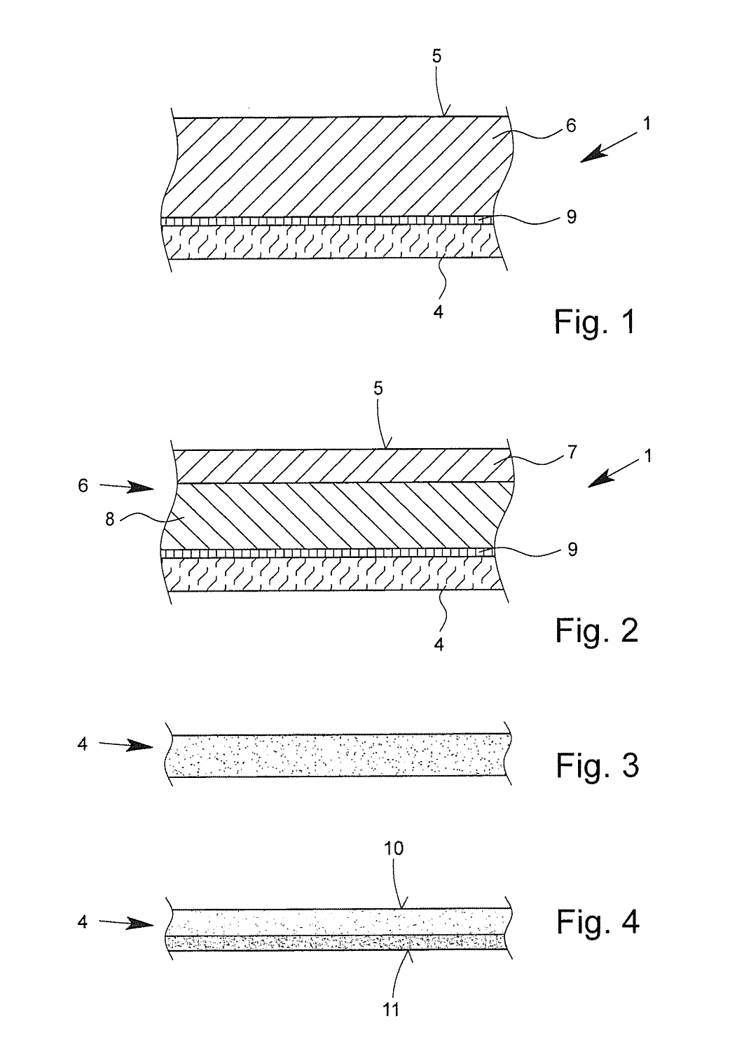

FIGS. 1 and 2 show different embodiments of a cover layer 1 which is intended for a panel 3 which has a panel base body 2. The panel 3 can have different applications. In particular, the panel is possible as a floor covering panel, wall panel or ceiling sheathing panel and/or also as a furniture component panel, building panel, covering panel or dry finish panel and/or as a facade element, panel element or board element or as a trimming plate. One preferred application of the cover layer 1 is used as a so-called overlay for producing footfall-damped floors.

The cover layer 1 has a paper layer 4 and a film layer 6 of an elastic plastic which forms the outside 5 of the cover layer 1. The embodiments of FIGS. 1 and 2 differ in that the film layer 6 in the embodiment as shown in FIG. 1 has one layer, while it has two layers in the embodiment as shown in FIG. 2.

Regardless of whether it has one or several layers, the film layer 6 is formed of a physically or chemically cross-linked polymer, thermoplastic polyurethane-based elastomers being preferred. For the two-layer structure as shown in FIG. 2, in which there are an outer layer 7 and a functional layer 8, it is preferred that the outer layer 7 has a greater Shore hardness than the functional layer 8. Here, the outer layer 7 has a Shore hardness from Shore 90 A to Shore 80 D, while the functional layer 8 has a Shore hardness from Shore 50 A to a maximum Shore 90 A. The thickness of the functional layer 8 is greater by a factor of 2 to 100 than the thickness of the outer layer. Preferably, the outer layer 7 has a layer thickness from 5 μm to 100 μm and the functional layer 8 has a layer thickness between 100 μm and 500 μm. On the outer side 5, there can be a three-dimensional surface structure which has been produced by embossing and which corresponds for example to wood graining which is printed on the paper layer 4.

It is not shown that the film layer 6 can also have more than two layers. Thus, a three-layer or four-layer structure is easily possible. Fundamentally, any number of layers is possible. In particular, it is possible for the layer structuring of the film layer 6 with layers 7 and 8 to take place in alternation.

Overall, the film layer 6 is transparent so that the printing which is generally provided on the paper layer 4 is recognizable through the film layer 6. Between the paper layer 4 and the film layer 6, in the illustrated exemplary embodiments, there is an adhesive layer 9. Here, it can be, for example, a cement layer or glue layer. In any case, the adhesive layer can fundamentally also be omitted when a direct connection between the layers 4 and 6 is possible by choosing a corresponding material of the film layer 6 and of the paper layer 4.

It is provided at this point that the paper layer 4 which is a decorative paper here is only partially impregnated. This partial impregnation differs from complete or thorough impregnation in that, for a partially impregnated decorative paper, the maximum pore volume which is available for taking up the binder/resin is only partially filled, therefore a portion with a free pore volume remains. Accordingly, the degree of the binder which has been absorbed during impregnation for a partially impregnated decorative paper is smaller than for a fully or thoroughly impregnated decorative paper. The paper layer 4 can be a so-called preimpregnate. A preimpregnate constitutes a decorative paper which has already been partially impregnated during paper manufacture. But fundamentally, it is also possible to only partially impregnate a decorative paper after paper manufacture. Preferably, the degree of impregnation is between 20 and 80%. Here, the degree of impregnation is the relative absorption capacity of the decorative paper to absorb binder. A completely impregnated or thoroughly impregnated decorative paper has a degree of impregnation of 100%, while an unimpregnated decorative paper has a degree of impregnation of 0%.

FIG. 3 shows a paper layer 4 which, after impregnation with the binder or impregnation agent, has a degree of impregnation in the range of 30%, which degree is uniform over the thickness of the paper layer. Conversely, in the embodiment shown in FIG. 4, it is provided that the degree of impregnation increases from the top side 10 of the paper layer which faces the film layer 6 to the bottom side 11. Fundamentally, there can be a continuous or uniform increase of the degree of impregnation over the layer thickness. In the illustrated exemplary embodiment for example the lower half of the thickness of the paper layer 4 is provided with a higher degree of impregnation, here roughly 35% to 40%, and the upper part with a smaller degree of impregnation, here roughly 25% to 30%. For partial impregnation of the paper layer 4, duroplastic resins or acrylate binders can be used. In particular aminoplastic-based resins as well as latex dispersions or PU dispersion are used.

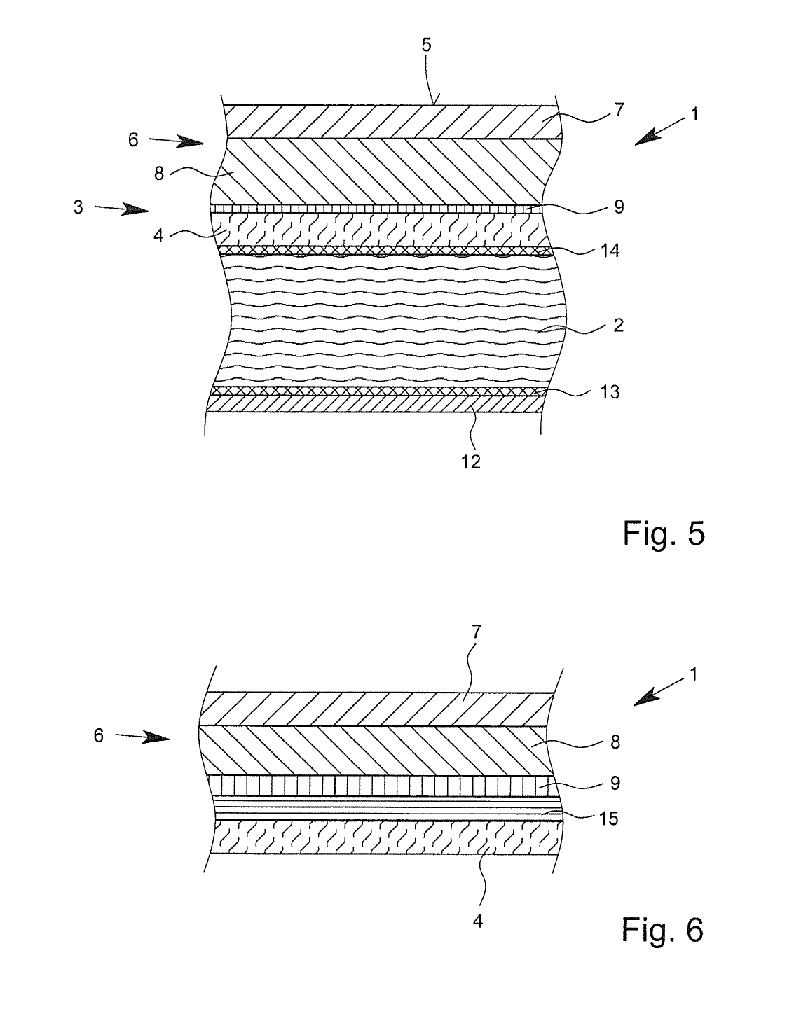

FIG. 5 schematically shows the layer structure of a panel 3. The panel 3 has a panel base body 2 of a wood material. Here it can be, for example, an MDF (Medium Density Fiberboard) or HDF (High Density Fiberboard) panel. It goes without saying that, instead of a wood material, also other carrier materials can be provided, such as plastic materials, metals, steel, gypsum or the like as well as composite materials. The thickness of the panel base body 2 is at least 5 mm. Greater thicknesses are easily possible. It is not shown that the panel 3 is profiled on the edge side in the region of the panel base body 2 in order to be positively and/or frictionally joined to adjacent panels 3 via the profiling. Preferably, the panel base body 2 has so-called click joining profiles on opposite sides, the profiles working in the manner of a tongue and groove system. Here, the panel, especially, has the shape of an elongated rectangle when it is being used as a panel element. The dimensions are fundamentally optional.

On the bottom side of the panel 3 there is a contacting layer 12. The latter is connected to the panel base body 2 via an adhesive layer 13 which is, for example, a cement layer or a glue layer. The contacting layer 12 is a shape stability layer. It is expressly pointed out that the implementation of the contacting layer 12 is basically advantageous, and in practice, in any case, is the rule for panel elements, However, the contacting layer 12 need not necessarily be provided.

On the top side, on the panel base body 2, is the cover layer 1 which is connected to the panel base body 2 via an adhesive layer 14 which is, for example, a cement layer or a glue layer. In any case, the adhesive layer 14 can also fundamentally be omitted when the film layer 6 is directly joined to the paper layer 4 when a corresponding material is chosen.

In conjunction with the invention, tests have been run with a cover layer 1 according to FIG. 2, a cover layer according to FIG. 2 with an unimpregnated decorative paper (degree of impregnation 0%) and a cover layer according to FIG. 2, but in conjunction with a thoroughly impregnated decorative paper (degree of impregnation of 100%). Here, the peel strength, the adhesive strength, the interlaminar strength and the delamination strength were studied with the following result:

| | | | | Inter- | |
|---|---|---|---|---|---|
| | | | Adhesive | laminar | |
| | | | strength | strength | Delamina- |
| | | | test | according to | tion |
| | Peel | | lattice cut | Scott Bond | strength |
| | strength | | ISO 2409 | method | EN 13329 |
| Cover layer | 2.2-2.8 | N/cm | Stage 0 | 2040 J/m² | 1.18 N/mm² |
| according to | | | | | |
| FIG. 2 with | | | | | |
| partially | | | | | |
| impregnated | | | | | |
| decorative | | | | | |
| paper | | | | | |
| Cover layer | <1 | N/cm | Stage 5 | 600 J/m² | 0.46 N/mm² |
| according to | | | | | |
| FIG. 2 with | | | | | |
| unimpregnated | | | | | |
| decorative | | | | | |
| paper | | | | | |
| Cover layer | <0.5 | N/cm | Stage 5 | 1000 J/m² | 1.17 N/mm² |
| according to | | | | | |
| FIG. 2 with | | | | | |
| thoroughly | | | | | |
| impregnated | | | | | |
| decorative | | | | | |
| paper | | | | | |

Furthermore, the partial impregnate, i.e., the raw paper according to FIG. 3, an unimpregnated decorative paper and a thoroughly impregnated decorative paper have been examined with respect to the edge swelling and the water absorption with the following result:

| | Edge swelling raw | Water absorption raw |
|---|---|---|
| | paper 60 min | paper 15 min |
| Partially impregnated | 22.46% | 45.14% |
| decorative paper | | |
| (preimpregnate) | | |
| Unimpregnated decorative | 43.07% | 92.77% |
| paper | | |
| Thoroughly impregnated | 8.80% | 37.89% |
| decorative paper | | |

FIG. 6 shows a cross sectional view of another embodiment of a cover layer 1 in accordance with the invention. The cover layer 1, in this exemplary embodiment, is made with five layers. In addition to the outer layer 7 which forms the wear layer, and the functional layer 8 which lies underneath the outer layer 7, there is the adhesive layer 9. The layers 7, 8, 9 form the film layer 6. The adhesive layer 9 forms the boundary layer to the paper. Underneath the adhesive layer 9 is a partially impregnated decorative paper which has a bottom paper layer 4 and an overlying boundary layer 15 to the film layer 6. This boundary layer 15 can be formed by the resin or binder which is used for impregnation of the paper layer and/or formed by the printing ink.

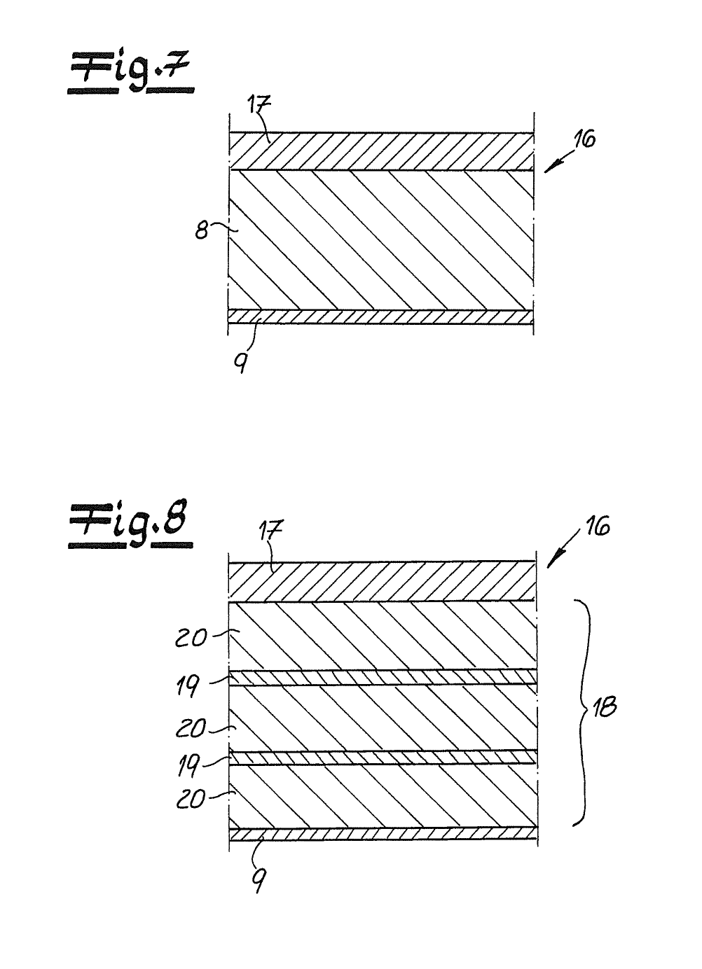

The film layer 6 can also be applied by an extrusion coating to the paper layer 4 which is prepared as partially impregnated preimpregnate or as partially impregnated paper. The film layer 6 can also be prepared in the form of a prefabricated, multilayer film 16 which is applied to the partially impregnated paper by means of a lamination process. FIG. 7 shows the layer structure of a multilayer film 16 which is suitable for the cover layer in accordance with the invention. The multilayer film 16 has a top wear layer 17 of a physically or chemically cross-linked polymer, at least one functional layer 8 likewise consisting of a physically or chemically cross-linked polymer, and a bottom adhesive layer 9. The functional layer 8 is located between the wear layer 17 and the adhesive layer 9, and in the exemplary embodiment of FIG. 7, it has a lower Shore hardness than the wear layer 17 over its entire thickness. The adhesive layer 9 is made such that it forms a bonded combination with a partially impregnated paper by using pressure and/or temperature. The adhesive layer preferably is formed of one or more copolymers based on polyamide, acrylate or urethane.

The wear layer 17 and the functional layer 8 of the film shown in FIG. 7 are coextruded. The functional layer of the film in the above described applications absorbs mechanical shocks and has an effective footfall sound-damping effect. The wear layer imparts to the surface a high scratch resistance, low abrasion values and pleasant feel. When using the cover layer on a laminate panel the feet are pleasantly warmed.

The wear layer can, in particular, have a Shore hardness of greater than 90 A to Shore 80 D, a hardness of roughly Shore 60 D being preferred. The Shore hardness of the functional layer is especially in the range Shore 50 A to a maximum Shore 90 A, for the functional layer a Shore hardness of roughly Shore 70 A being preferred.

The wear layer 17 and the functional layer 8 can be made of olefin-based thermoplastic elastomers (TPE-O), cross-linked olefin-based thermoplastic elastomers (TPE-V), urethane-based thermoplastic elastomers (TPE-U), thermoplastic polyester elastomers (TPE-E), styrene block copolymers (TPE-S) or thermoplastic copolyamides (TPE-A). Preferably, the wear layer and the functional layer are formed of urethane-based thermoplastic elastomers (TPE-U). The wear layer can have a three-dimensional surface structure which has been producing by embossing, and fine structures as are typical, for example, for veneers can be permanently introduced into the wear layer 17.

The thickness of the film layers 17, 8 is dependent on the application and can be varied in a wide range of parameters. For the above described applications, the wear layer 17 and the functional layer 8, together, advantageously have a total thickness between 50 μm and 2000 μm, the thickness of the functional layer 8 being greater by a factor of 2 to 100 than the thickness of the wear layer 17.

The film is preferably transparent for the aforementioned applications. Furthermore the wear layer 17 can contain additives for example for improving flame retardant properties, improving electrostatic behavior, and the like.

In the exemplary embodiment shown in FIG. 8, the functional layer 8 of the film has a layer arrangement 18 of a plurality of coextruded layers 19, 20, the layers each being formed of a physically or chemically cross-linked thermoplastic polymer. In the layer arrangement, hard layers 19 which have a corresponding or comparable Shore hardness as the wear layer 17, and soft layers 20 are arranged in alternation. Here, a soft layer 20 borders the underside of the wear layer 17. The sequence of hard layers and soft layers causes a better distribution of compressive loads and results in improved solid-borne sound damping or footfall-sound damping.

What is claimed is:

1. A cover layer for a panel which has a panel base body, comprising
a paper layer and
a film layer of elastic plastic which forms an outer side of the cover layer,
wherein the paper layer is a preimpregnate which has been partially impregnated either before, during or after paper manufacture.

2. The cover layer in accordance with claim 1, wherein the cover layer has a peel strength of the cover layer between 2 to 3 N/cm

3. The cover layer in accordance with claim 1, wherein the cover layer has a lattice cut characteristic value (Gt) according to ISO 2049 of 3.

4. The cover layer in accordance with claim 1, wherein the cover layer has a lattice cut characteristic value (Gt) according to ISO 2049 of 1 or 0.

5. The cover layer in accordance with claim 1, wherein the cover layer has an interlaminar strength measured using the Scott Bond method of greater than 1500 J/mm².

6. The cover layer in accordance with claim 1, wherein the cover layer has an interlaminar strength measured using the Scott Bond method of between 1900 and 2200 J/mm².

7. The cover layer in accordance with claim 1, wherein the cover layer has a delamination strength according to EN 13329 greater than 0.7 N/mm².

8. The cover layer in accordance with claim 1, wherein the cover layer has a delamination strength according to EN 13329 between 1.1 and 1.3 N/mm².

9. The cover layer in accordance with claim 1, wherein the paper layer as a raw paper has edge swelling after 60 minutes from 10 to 35%.

10. The cover layer in accordance with claim 1, wherein the paper layer as raw paper has water absorption after 15 minutes between 30 to 60%.

11. The cover layer in accordance with claim 1, wherein the paper layer has a degree of impregnation between 5% and 50%.

12. The cover layer in accordance with claim 1, wherein the paper layer has a degree of impregnation between 20% and 30%.

13. The cover layer in accordance with claim 1, wherein the degree of impregnation of the paper layer increases from a top side of the paper layer to a bottom side of the paper layer.

14. A multilayer film, comprising:
a preimpregnate paper layer preimpregnate which has been partially impregnated either before, during or after paper manufacture
a film layer of elastic plastic which forms an outer side of the cover layer,
a top wear layer of a physically or chemically cross-linked polymer,
at least one functional layer formed of a physically or chemically cross-linked polymer and
a bottom adhesive layer,
wherein the functional layer is located between the wear layer and the adhesive layer and at least in a zone bordering the wear layer has a lower Shore hardness than the wear layer and
wherein the adhesive layer forms a bonded combination with the partially impregnated paper layer.

15. The multilayer film in accordance with claim 14, wherein the adhesive layer is formed of at least one copolymer selected from the group consisting of polyamides, acrylates and urethanes.

16. The multilayer film in accordance with claim 14, wherein the wear layer and the functional layer have been coextruded.

17. The multilayer film in accordance with claim 14, wherein the wear layer has a Shore hardness greater than Shore 80 D.

18. The multilayer film in accordance with claim 14, wherein a zone of the functional layer bordering the wear layer has a Shore hardness of from Shore 50 A to a maximum of Shore 90 A.

19. The multilayer film in accordance with claim 14, wherein the wear layer and the functional layer are made of a thermoplastic elastomer.

20. The multilayer film in accordance with claim 14, wherein the wear layer and the functional layer together have a total thickness between 50 μm and 2000 μm, the thickness of the functional layer being greater by a factor of 2 to 100 than the thickness of the wear layer.

21. The multilayer film in accordance with claim 14, wherein the functional layer has a layer arrangement of a plurality of coextruded layers each of is formed of a physically or chemically cross-linked polymer, the coextruded layers being an alternating arrangement of hard layers which have a Shore hardness corresponding to that of the wear layer and softer layers.

22. The multilayer film in accordance with claim 14, wherein the wear layer has a three-dimensional surface structure which has been produced by embossing.

23. The multilayer film in accordance with claim 14, wherein the wear layer contains additives from the group consisting of materials have at least one of flame retardant properties, electrostatic behavior reducing properties.

24. The multilayer film in accordance with claim 14, wherein the film layer and the top wear layer are transparent.

25. A panel, comprising:
a panel base body and
a cover layer connected to the panel base body, the cover layer comprising:
a paper layer and
a film layer of elastic plastic which forms an outer side of the cover layer,
wherein the paper layer is a preimpregnate which has been partially impregnated either before, during or after paper manufacture.

26. The panel according to claim 25, wherein said panel is one of a floor covering panel, wall panel, ceiling sheathing panel, furniture component panel, building panel, covering panel, dry finish panel, facade element, and trim plate.
